(19) United States
(12) Patent Application Publication
(10) Pub. No.: US 2025/0080340 A1
(43) Pub. Date: Mar. 6, 2025

(54) SYSTEM, METHOD, AND COMPUTER PROGRAM FOR GENERATING VEHICLE IDENTIFICATION

(71) Applicant: TOYOTA JIDOSHA KABUSHIKI KAISHA, Toyota-shi (JP)

(72) Inventor: Caleb MCGARY, Tokyo (JP)

(73) Assignee: TOYOTA JIDOSHA KABUSHIKI KAISHA, Toyota-shi (JP)

(21) Appl. No.: 18/459,895

(22) Filed: Sep. 1, 2023

(51) Int. Cl. H04L 9/08; G06F 21/57; H04L 9/32

(52) U.S. Cl. CPC H04L 9/0861; G06F 21/575; H04L 9/3247

(57) ABSTRACT

Provided are system, method, and device for generating an identification for a vehicle system. According to embodiments, the system may include: a memory storage storing computer-executable instructions; and at least one processor communicatively coupled to the memory storage, wherein the at least one processor may be configured to execute the instructions to: determine whether all of a plurality of control units within a vehicle have successfully secure booted; and in response to determining that all of the plurality of control units have successfully secure booted, generate an identification for the vehicle based on the plurality of control units that have successfully secure booted.

### TECHNICAL FIELD

Systems, methods, and computer programs consistent with example embodiments of the present disclosure relate to a vehicle system, and more specifically, relate to generating an identification for a vehicle system.

### BACKGROUND

Modern vehicles are capable of performing a wide range of complex functions, such as generating telemetry data, transmitting and receiving data via the internet, and the like. In order for the vehicles to perform the above functions, said vehicles are inherently connected to an upstream server.

In the related art, in order for the server to identify a specific vehicle from among a plurality of vehicles communicating with the sever, a vehicle identification number (VIN) may be used. The VIN may refer to a code comprising of a plurality of characters (e.g., numerical numbers, alphabetical letters, combination thereof, and the like) that act as a unique identifier of a specific vehicle. The VIN may be given to the vehicle during the manufacture of said vehicle, and may identify and specify the major components, specification, manufacturer, and the like of the vehicle.

Nevertheless, the above approach for identifying a specific vehicle using the VIN may have at least the following shortcomings. Since the VIN is only associated with some components (e.g., major components) of the vehicle and may not be associated with crucial components of the vehicle, such configuration may presents privacy and security issues.

Further, different VINs may be implemented based on different competing standards, which may result in different VINs having different formats. This may cause difficulties for the server to identify a particular vehicle, as a certain server may not be configured to read a certain format of VINs, may misinterpret a VIN having a different format to specify an incorrect vehicle, and the like. As globalization allows vehicles to move between different countries (utilizing different standards of VINs) more frequently, the above issue has become more prevalent.

Furthermore, the use of VIN may not comply with privacy laws, such as the General Data Protection Regulation (GDPR) privacy law, which permit having an identifier that is persistent and cannot be reset.

### SUMMARY

Example embodiments of the present disclosure automatically generate an identification for a vehicle system, based on a plurality of control units that have successfully secure booted. As such, example embodiments of the present disclosure improve privacy and security, standardize the identification format, and reduce risk of non-compliance with privacy laws.

According to embodiments, a system is provided. The system may include: a memory storage storing computer-executable instructions; and at least one processor communicatively coupled to the memory storage, wherein the at least one processor may be configured to execute the instructions to: determine whether all of a plurality of control units within a vehicle have successfully secure booted; and in response to determining that all of the plurality of control units have successfully secure booted, generate an identification for the vehicle based on the plurality of control units that have successfully secure booted.

According to embodiments, the identification may specify a plurality of cryptographic signatures associated with the plurality of control units that have successfully secure booted, and each of the plurality of cryptographic signatures may be unique.

According to embodiments, the at least one processor may be configured to execute the instructions to: in response to determining that not all of the plurality of control units have successfully secure booted, re-boot a failed control unit that has not successfully secure boot; determine whether the failed control unit has successfully re-booted; and in response to determining that the failed control unit has not successfully re-booted, disable one or more non-essential functions of the vehicle.

According to embodiments, the plurality of control units may include a central control unit and one or more secondary control unit; the central control unit may include the memory and the at least one processor; and the at least one processor may be configured to execute the instructions to determine whether all of the plurality of control units have successfully secure booted by: performing a secure boot; determining whether the secure boot was a success; in response to determining that the secure boot was a success, transmitting a request for a status of the one or more secondary control unit to the one or more secondary control unit; receiving the status of the one or more secondary control unit from the one or more secondary control unit; and determining whether the one or more secondary control unit has successfully secure booted based on the status.

According to embodiments, the at least one processor may be configured to execute the instructions to, in response to failing the secure boot, transmitting a first failure notification to the one or more secondary control unit; and the one or more secondary control unit may be configured to, in response to receiving the first failure notification, select one control unit from the plurality of control units different from the central control unit as a new central control unit.

According to embodiments, the status of the one or more second control unit may be cryptographically signed by the corresponding one or more second control unit using a cryptographic key.

According to embodiments, the plurality of control units may include an Electronic Control Unit (ECU).

According to embodiments, the identification may include a Software Bill of Material (SBOM).

According to embodiments, the at least one processor may be configured to execute the instructions to transmit the identification to a server via an Elliptic Curve Integrated Encryption Scheme (ECIES).

According to embodiments, a method is provided. The method may include: determining whether all of a plurality of control units within a vehicle have successfully secure booted; and in response to determining that all of the plurality of control units have successfully secure booted, generating an identification for the vehicle based on the plurality of control units that have successfully secure booted.

According to embodiments, the identification may specify a plurality of cryptographic signatures associated with the plurality of control units that have successfully secure booted, and each of the plurality of cryptographic signatures may be unique.

According to embodiments, the method may further include: in response to determining that not all of the plurality of control units have successfully secure booted, re-booting a failed control unit that has not successfully secure boot; determining whether the failed control unit has successfully re-booted; and in response to determining that the failed control unit has not successfully re-booted, disabling one or more non-essential functions of the vehicle.

According to embodiments, the plurality of control units may include a central control unit and one or more secondary control unit; and the determining whether all of the plurality of control units within the vehicle have successfully secure booted may include: performing, by the central control unit, a secure boot; determining, by the central control unit, whether the secure boot was a success; in response to determining that the secure boot was a success, transmitting, by the central control unit, a request for a status of the one or more secondary control unit to the one or more secondary control unit; receiving, by the central control unit, the status of the one or more secondary control unit from the one or more secondary control unit; and determining, by the central control unit, whether the one or more secondary control unit has successfully secure booted based on the status.

According to embodiments, the method may further include: in response to failing the secure boot, transmitting, by the central control unit, a first failure notification to the one or more secondary control unit; and in response to receiving the first failure notification, selecting, by the one or more secondary control unit, one control unit from the plurality of control units different from the central control unit as a new central control unit.

According to embodiments, the status of the one or more second control unit may be cryptographically signed by the corresponding one or more second control unit using a cryptographic key.

According to embodiments, the plurality of control units may include an Electronic Control Unit (ECU).

According to embodiments, the identification may include a Software Bill of Material (SBOM).

According to embodiments, the at least one processor may be configured to execute the instructions to transmit the identification to a server via an Elliptic Curve Integrated Encryption Scheme (ECIES).

According to embodiments, a non-transitory computer-readable recording medium is provided. The non-transitory computer-readable recording medium may have recorded thereon instructions executable by at least one processor of a system to cause the at least one processor to perform a method including: determining whether all of a plurality of control units within a vehicle have successfully secure booted; and in response to determining that all of the plurality of control units have successfully secure booted, generating an identification for the vehicle based on the plurality of control units that have successfully secure booted.

According to embodiments, the identification may specify a plurality of cryptographic signatures associated with the plurality of control units that have successfully secure booted, and each of the plurality of cryptographic signatures may be unique.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates a block diagram of an example system configuration for generating an identification for the vehicle, according to one or more embodiments;

FIG. 2 illustrates a block diagram of a first example components in a Vehicle Identification Generation (VIG) system, according to one or more embodiments;

FIG. 3 illustrates a block diagram of a second example components in a Vehicle Identification Generation (VIG) system, according to one or more embodiments;

FIG. 4 illustrates a flow diagram of an example method for generating an identification for a vehicle, according to one or more embodiments;

FIG. 5 illustrates a flow diagram of an example method for validating and generating an identification for a vehicle, according to one or more embodiments;

FIG. 6 illustrates a flow diagram of an example method for determining whether all of the plurality of control units in a vehicle have successfully secure booted, according to one or more embodiments;

FIG. 7 illustrates a flow diagram of an example secure boot process, according to one or more embodiments; and

FIG. 8 illustrates a flow diagram of an example method for re-booting a failed control unit, according to one or more embodiments.

### DETAILED DESCRIPTION

The following detailed description of example embodiments refers to the accompanying drawings. The same reference numbers in different drawings may identify the same or similar elements.

The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are disclosed in the specification, these combinations are not intended to limit the disclosure of possible implementations. In fact, many of these features may be combined in ways not specifically disclosed in the specification.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Systems, methods, devices, and the like, provided in the example embodiments of the present disclosure automatically generate identification for a vehicle system (i.e., vehicle), based on a plurality of control units that have successfully secure booted.

According to embodiments, the system may determine whether all of a plurality of control units within a vehicle have successfully secure booted, and may generate an identification for the vehicle based on such determination. For instance, based on determining that all of the plurality of control units have successfully secure booted, the system may generate an identification for the vehicle based on the plurality of control units that have successfully secure booted.

Ultimately, example embodiments of the present disclosure automatically generate identification for a vehicle system, based on a plurality of control units that have successfully secure booted, which improve privacy and security, standardize the identification format, and reduce risk of non-compliance with privacy laws.

It is contemplated that features, advantages, and significances of example embodiments described hereinabove are merely a portion of the present disclosure, and are not intended to be exhaustive or to limit the scope of the present disclosure.

Further descriptions of the features, components, configuration, operations, and implementations of the threshold tuning system of the present disclosure, according to one or more embodiments, are provided in the following.

### Example System Architecture

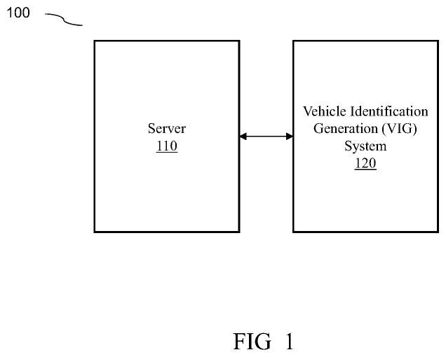

FIG. 1 illustrates a block diagram of an example system configuration 100 for generating an identification for the vehicle, according to one or more embodiments. As illustrated in FIG. 1, system configuration 100 may include a server 110 and a Vehicle Identification Generation (VIG) system 120.

Server 110 may include a cloud server, a hybrid cloud server, a server cluster, and the like. Server 110 may be remote from the VIG system 120, and may be communicatively coupled to the VIG system 120.

VIG system 120 may include a system, a platform, a module, or the like, which may be configured to perform one or more operations or actions for generating an identification for a vehicle. According to embodiments, the VIG system 120 may be comprised in the vehicle.

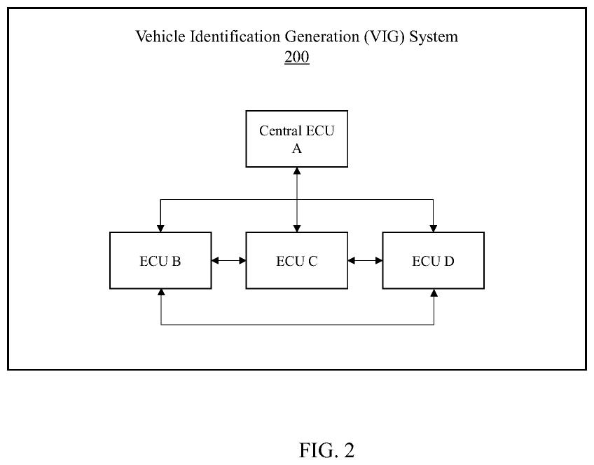

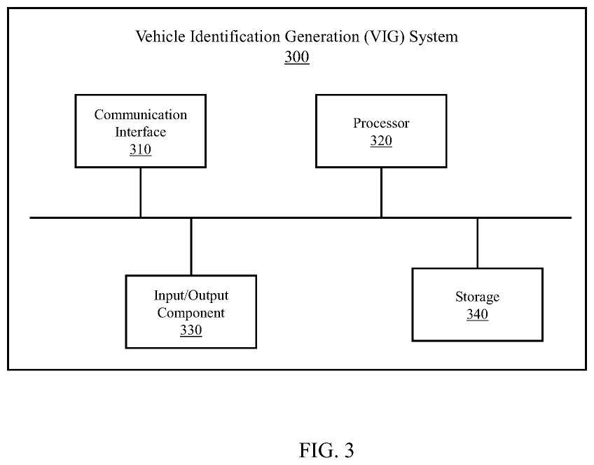

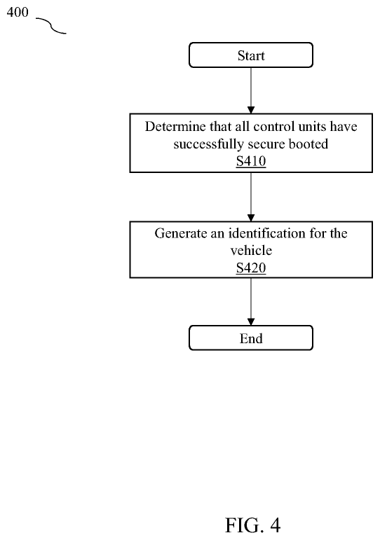

Example operations performable by the VIG system 120 for generating an identification for the vehicle are described below with reference to FIG. 4 to FIG. 8. Further, several example components which may be included in the VIG system 120, according to one or more embodiments, are described below with reference to FIG. 2 and FIG. 3.

FIG. 2 illustrates a block diagram of example components in a VIG system 200, according to one or more embodiments. The VIG system 200 may corresponds to the VIG system 120 in FIG. 1, thus the features associated with the VIG system 120 and the VIG system 200 may be similarly applicable to each other, unless being explicitly described otherwise.

As illustrated in FIG. 2, the VIG system 200 may include a plurality of control units: control unit A, control unit B, control unit C, and control unit D. According to embodiments, each of the control units may be communicatively coupled to each other. According to embodiments, one of the plurality of control units may be configured as a central control unit (e.g., control unit A), which acts to perform functions to generate an identification for a vehicle. According to embodiments, the plurality of control units may include an electronic control unit (ECU), which controls one or more electrical systems in a vehicle. For example, the plurality of control units may include an engine control unit, a brake control unit, a general electronic unit, an advanced driver assistance system, and the like.

It can be understood that the VIG system 200 may include more or less control units than as illustrated in FIG. 2, and/or may be arranged in a manner different from as illustrated in FIG. 2, without departing from the scope of the present disclosure.

FIG. 3 illustrates a block diagram of example components in a VIG system 300, according to one or more embodiments. The VIG system 300 may corresponds to the VIG system 120 in FIG. 1 and the VIG system 200 in FIG. 2, thus the features associated with the VIG system 120, the VIG system 200, and the VIG system 300 may be similarly applicable to each other, unless being explicitly described otherwise.

As illustrated in FIG. 3, the VIG system 300 may include at least one communication interface 310, at least one processor 320, at least one input/output component 330, and at least one storage 340. According to embodiments, the at least one communication interface 310, the at least one processor 320, the at least one input/output component 330, and the at least one storage 340 may be comprised in each of the control units of the VIG system (e.g., control units A, B, C, and D).

It can be understood that the VIG system 300 may include more or less components than as illustrated in FIG. 3, and/or may be arranged in a manner different from as illustrated in FIG. 3, without departing from the scope of the present disclosure.

The communication interface 310 may include at least one transceiver-like component (e.g., a transceiver, a separate receiver and transmitter, a bus, etc.) that enables the components of the VIG system 300 to communicate with each other and/or to communicate with one or more components external to the VIG system 300, such as via a wired connection, a wireless connection, or a combination of wired and wireless connections.

For instance, the communication interface 310 may couple the processor 320 to the storage 340 to thereby enable them to communicate and to interoperate with each other in performing one or more operations. As another example, communication interface 310 may couple the VIG system 300 (or one or more components included therein) to the server 110, so as to enable them to communicate and to interoperate with each other.

According to one or more embodiments, the communication interface 310 may include one or more application programming interfaces (APIs) which allow the VIG system 300 (or one or more components included therein) to communicate with one or more software applications (e.g., software application deployed in the server 110, etc.).

The input/output component 330 may include at least one component that permits the VIG system 300 to receive information and/or to provide output information. It can be understood that, in some embodiments, the input/output component 330 may include at least one input component (e.g., a touch screen display, a button, a switch, a microphone, a sensor, etc.) and at least one output component (e.g., a display, a speaker, one or more light-emitting diodes (LEDs), etc.), each of which may be separated from each other.

The storage 340 may include one or more storage mediums suitable for storing data, information, and/or computer-executable instructions therein. According to embodiments, the storage 340 may include at least one memory storage, such as a random access memory (RAM), a read only memory (ROM), and/or another type of dynamic or static storage device (e.g., a flash memory, a magnetic memory, and/or an optical memory) that stores information and/or instructions for use by the processor 320. Additionally or alternatively, the storage 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to embodiments, the storage 340 may be configured to store information, such as raw data, metadata, or the like, obtained from the server 110. Additionally or alternatively, the storage 340 may be configured to store one or more information associated with one or more operations performed by the processor 320. For instance, the storage 340 may store information defining the historical operation(s) performed by the processor 320 to generate an identification, one or more results of operations performed by the processor 320, or the like. Further, the storage 340 may store data or information required in generating the identification.

In some implementation, the storage 340 may include a plurality of storage mediums, and the storage 340 may be configured to store a duplicate or a copy of at least a portion of the information in the plurality of storage mediums, for providing redundancy and for backing-up the information or the associated data. Furthermore, the storage 340 may also store computer-readable or computer-executable instructions which, when being executed by one or more processors (e.g., processor 320), causes the one or more processors to perform one or more actions/operations described herein

The processor 320 may include at least one processor capable of being programmed or being configured to perform a function(s) or an operation(s) described herein. For instance, the processor 320 may be configured to execute computer-executable instructions stored in at least one storage medium or a memory storage (e.g., storage 340, etc.) to thereby perform one or more actions or one or more operations described herein.

According to embodiments, the processor 320 may be configured to receive (e.g., via the communication interface 310, via the input/output component 330, etc.) one or more signals and/or one or more user inputs defining one or more instructions for performing one or more operations. Further, the processor 320 may be implemented in hardware, firmware, or a combination of hardware and software. For instance, processor 320 may include at least one of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), and/or another type of processing or computing component.

According to embodiments, the processor 320 may be configured to collect, to extract, and/or to receive one or more information (in the form of signal or data, etc.) from the server 110, and to process the received one or more information to thereby generate the identification.

Descriptions of several example operations which may be performed by the processor 320 are provided below with reference to FIG. 4 to FIG. 8.

### Example Operations for Generating an Identification for a Vehicle in the Present Disclosure

In the following, several example operations performable by the VIG system of the present disclosure are described with reference to FIG. 4 to FIG. 8.

FIG. 4 illustrates a flow diagram of an example method 400 for generating an identification for a vehicle, according to one or more embodiments. One or more operations in method 400 may be performed by at least one processor (e.g., processor 320) of the VIG system. According to embodiments, the VIG system may be comprised in a vehicle, and may comprise a plurality of control units that control electrical systems in the vehicle. According to embodiments, the plurality of control units may include a central control unit and one or more secondary control unit (i.e., control unit in the plurality of control units other than the central control unit), where one or more operations in method 400 may be performed by the central control unit. According to embodiments, one or more operations in method 400 may be performed during a start-up process of the vehicle. According to embodiments, the plurality of control units may include an electronic control unit (ECU).

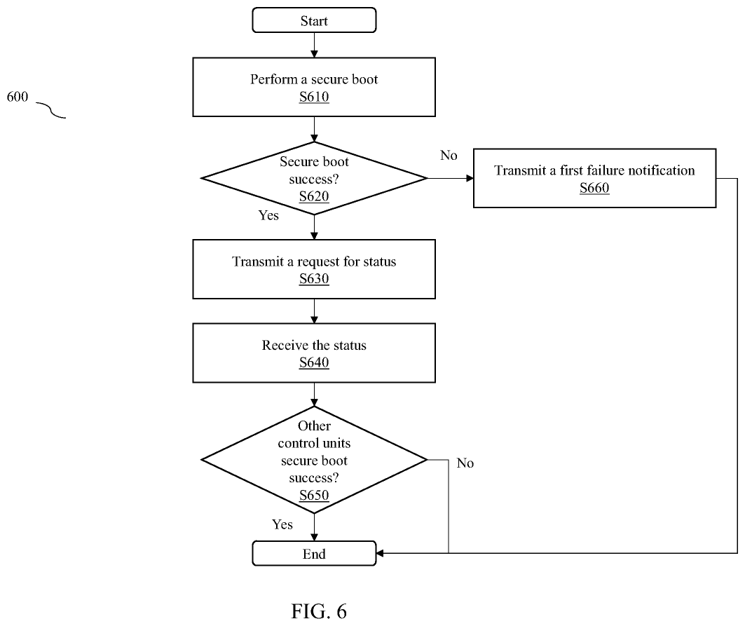

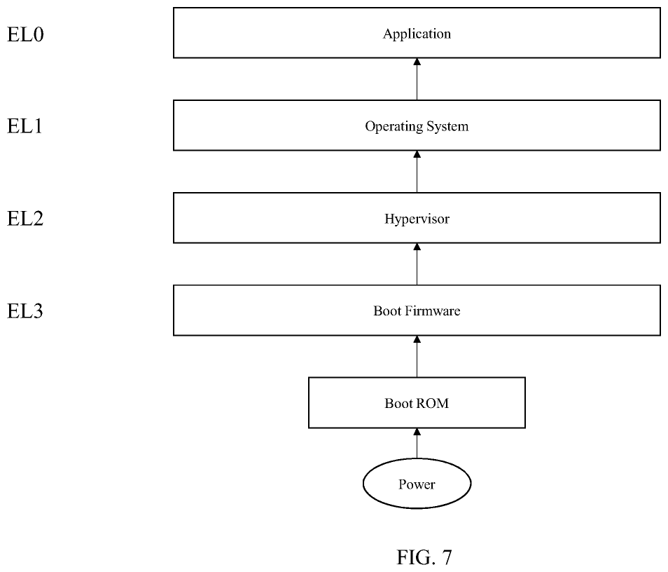

As illustrated in FIG. 4, at operation S410, the at least one processor may be configured to determine whether all of the plurality of control units in a vehicle have successfully secure booted. It may be understood that, during the start-up process of the vehicle, each of the plurality of control units in the vehicle is configured to perform a secure boot process, and the at least one processor may be configured to determine whether all of the plurality of control units have succeeded in such process. Descriptions related to the secure boot process and the determination of whether all of the plurality of control units have successfully secure booted are described below with reference to FIG. 6 and FIG. 7. The method then proceeds to operation S420.

At operation S420, in response to determining that all of the plurality of control units have successfully secure booted during operation S410, the at least one processor may be configured to generate an identification for the vehicle based on the plurality of control units that have successfully secure booted. According to embodiments, the identification may specify a plurality of cryptographic signatures associated with the plurality of control units that have successfully secure booted, where each of the plurality of cryptographic signatures is unique.

According to embodiments, each of the control units (e.g., ECUs) may be embedded with a set of public and private cryptographic keys during its manufacture by the manufacturer. Such keys may be embedded in the Hardware Security Module (HSM) on the SOC of the control unit, which permits only the control unit to utilize such keys to provide a cryptographic signature and prevents any 3rd party attacker from using such keys. Further, each of the set of keys (and the corresponding signature) is unique, such that no two control units can provide the same cryptographic signature, regardless of whether the control units are manufactured by the same manufacturer, are manufactured in the same batch, have the same model, and the like. According to embodiments, the cryptographic signature of the one or more secondary control unit may be received by the central control unit as part of the determination of whether all of the plurality of control units have successfully secure booted.

According to embodiments, the identification may include a Software Bill of Material (SBOM), which specify a plurality of cryptographic signatures associated with the plurality of control units that have successfully secure booted.

It may be understood that, since each of the cryptographic signatures is unique to a specific control unit, the identification (which specify a combination of such unique signatures) is also unique such that it may be used to identify a specific vehicle that has the specific control units corresponding to the specific signatures in the identification. Further, since the identification simply specify a combination of unique signatures, the format for the identification for the vehicle may be standardized, regardless of location.

Upon performing operation S420, the method 400 may be ended or be terminated. Alternatively, method 400 may return to operation S410, such that the at least one processor may be configured to repeatedly perform, for at least a predetermined amount of time, the determining that all of the plurality of control units have successfully secure booted (at operation S410) and the generating the identification for the vehicle (at operation S420).

To this end, the system of the present disclosure may generate identification for a vehicle, based on a plurality of control units that have successfully secure booted.

### Example Operations for Validating and Generating an Identification for a Vehicle in the Present Disclosure

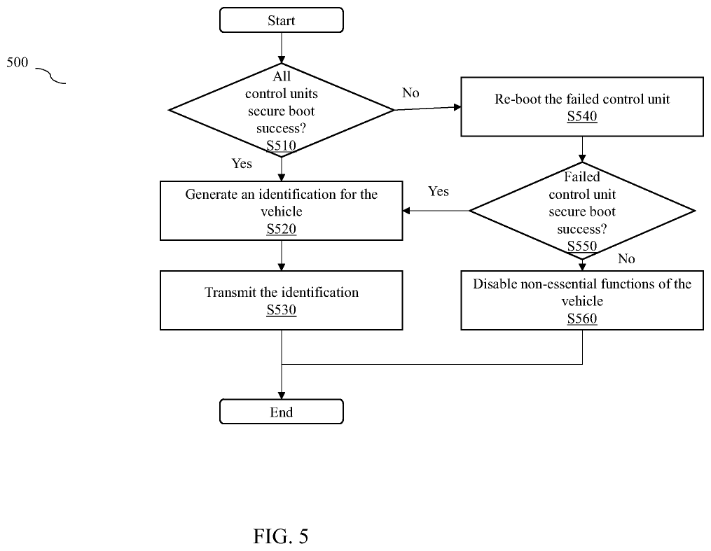

FIG. 5 illustrates a flow diagram of an example method 500 for validating and generating an identification for a vehicle, according to one or more embodiments. One or more operations of method 500 may be part of operation S410 and/or S420 in method 400, and may be performed by at least one processor (e.g., processor 320) of the VIG system.

As illustrated in FIG. 5, at operation S510, the at least one processor may be configured to determine whether all of the plurality of control units in a vehicle have successfully secure booted. It may be understood that, during the start-up process of the vehicle, each of the plurality of control units in the vehicle is configured to perform a secure boot process, and the at least one processor may be configured to determine whether all of the plurality of control units have succeeded in such process. Descriptions related to the secure boot process and the determination of whether all of the plurality of control units have successfully secure booted are described below with reference to FIG. 6 and FIG. 7.

Accordingly, based on determining that all of the plurality of control units in the vehicle have successfully secure booted, the at least one processor may determine that all of the plurality of control units in the vehicle are valid, and proceed to operation S520. On the other hand, based on determining that not all of the plurality of control units in the vehicle have successfully secure booted (i.e., one or more of the plurality of control units in the vehicle has failed the secure boot process), the at least one processor may determine that one or more of the plurality of control units in the vehicle may not be valid, and proceed to operation S540.

At operation S520, the at least one processor may be configured to generate an identification for the vehicle based on the plurality of control units that have successfully secure booted. According to embodiments, the identification may specify a plurality of cryptographic signatures associated with the plurality of control units that have successfully secure booted, in the similar manner as operation S420 in method 400. The method then proceeds to operation S530.

At operation S530, the at least one processor may be configured to transmit the identification to a server. According to embodiments, the server may refer to a server external to the vehicle, which the vehicle is communicating with in order to perform various functions. According to embodiments, the server may receive and store the identification, as well as utilize the identification in order to identify the vehicle. Specifically, since the identification specify a combination of unique signatures associated with particular control units in a particular vehicle, the server may be able to identify such particular vehicle based on whether or not a vehicle includes a combination of control units that are associated with the combination of unique signatures specified in the identification. Further, since the identification simply specify a combination of unique signatures, the format for the identification for the vehicle may be standardized, regardless of location.

According to embodiments, the at least one processor may be configured to transmit the identification to the server via an Elliptic Curve Integrated Encryption Scheme (ECIES). According to embodiments, the identification may be transmitted via the ECIES using the vehicle VIN as a salt for key generation. It may be understood that, using ECIES for encryption and transmission of data with the VIN as a salt enables blocking or banning of a key or vehicle from the server if needed.

According to embodiments, the server may store information related to the vehicle, such as the owner of the vehicle, software and hardware in the vehicle, and the like, which may be identified by the identification.

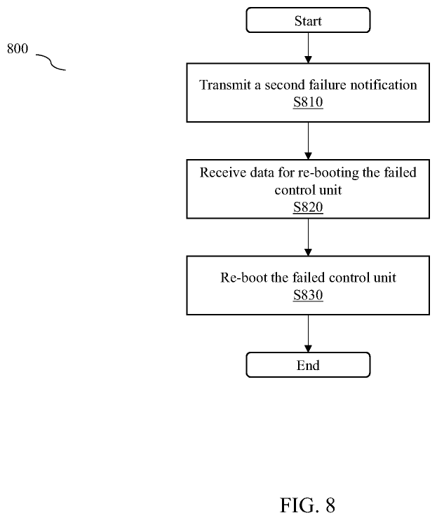

At operation S540, the at least one processor may be configured to re-boot a failed control unit. According to embodiments, the failed control unit may refer to the control unit that has not successfully secure boot. Descriptions related to re-booting the failed control unit are described below with reference to FIG. 8. The method then proceeds to operation S550.

At operation S550, the at least one processor may be configured to determine whether the failed control unit has successfully re-booted. According to embodiments, the at least one processor may be configured to determine whether the failed control unit that has successfully re-booted by transmitting a request for a status of the failed control unit to the failed control unit, receiving the status of the failed control unit from the failed control unit, and determining whether the failed control unit that has successfully re-booted based on the status, in the similar manner as operations S630, S640, and S650 in method 600 described below.

It may be understood that, if there are more than one failed control units, operations S540 and S550 may be performed for all of the failed control units.

Accordingly, based on determining that the failed control unit that has successfully re-booted, the at least one processor may determine that all of the plurality of control units in the vehicle are valid, and proceed to operation S520. On the other hand, based on determining that the failed control unit that has not successfully re-boot (i.e., the failed control unit has failed the re-boot process), the at least one processor may determine that one or more of the plurality of control units in the vehicle is not valid, and proceed to operation S560.

At operation S560, the at least one processor may be configured to disable one or more non-essential functions of the vehicle. According to embodiments, non-essential functions of the vehicle may refer to functions of the vehicle that are not directly related to the locomotion of the vehicle. For example, the non-essential functions may include online payment, weather report, video playback, and the like provided via an In-Vehicle-Infotainment (IVI) system of the vehicle. According to embodiments, the at least one processor may be configured to disable one or more non-essential functions of the vehicle, by preventing one or more non-safety-critical CAN signal from being transmitted and received within the vehicle, while allowing all safety-critical CAN signal to be transmitted and received within the vehicle.

According to embodiments, the at least one processor may be configured to disable one or more non-essential functions of the vehicle that is associated with the failed control unit. According to embodiments, the at least one processor may be configured to disable all non-essential functions of the vehicle, regardless of which functions are associated with the failed control unit.

It may be understood that, once the one or more non-essential functions of the vehicle is disabled, the only way to enable such function is to have trusted/verified entities, such as the seller, dealer, manufacturer, or the like of the vehicle enable such function. Such process prevents malicious hardware and/or software from being installed and compromise the vehicle. In particular, for example, if the user of the vehicle have credit card information installed in the IVI system of the vehicle in order to make online payments, the functions to make online payments should be disabled once untrusted/invalidated hardware and/or software is detected in the vehicle (i.e., by determining that not all of the plurality of control units have successfully secure booted and that the failed control unit cannot be re-booted). Further, enablement of such functions should be restricted to the trusted/verified entities, in order to improve the security and prevent any 3^{rd} party from easily compromising the vehicle.

It may also be understood that, while some or all non-essential functions of the vehicle should be disabled once untrusted/invalidated hardware and/or software is detected in the vehicle, essential functions of the vehicle, such as the functions to move and maneuver the vehicle, should not be disabled. This allows the vehicle to at least be operable to transport the user to the trusted/verified entities, as well as preventing any undesired accidents that may occur due to completely disabling all functions of the vehicle.

According to embodiments, once the one or more non-essential functions of the vehicle is disabled, a lock notification may be provided to the user. According to the embodiments, the lock notification may indicate to the user that one or more non-essential functions of the vehicle is disabled (locked), and that the user should visit the trusted/verified entities in order to enable such functions. According to embodiments, the lock notification may be in the form of an LED light.

Upon performing operation S530 or S560, the method 500 may be ended or be terminated.

Alternatively, upon performing operation S530, method 500 may return to operation S510, such that the at least one processor may be configured to repeatedly perform, for at least a predetermined amount of time, the determining whether all of the plurality of control units have successfully secure booted (at operation S510), the generating the identification for the vehicle (at operation S520), the transmitting the identification (at operation S530), the re-booting the failed control unit (at operation S540), the determining whether the failed control unit has successfully re-booted (at operation S550), and the disabling the one or more non-essential functions of the vehicle (at operation S560).

For example, once method 500 has ended upon performing operation S530 (where an identification is generated based on the signatures of the control units of the vehicle), the user may drive the vehicle to a location and stop the vehicle. Then, the next time the user starts the vehicle, the vehicle begins the boot process where method 500 may start again. Assuming that there are no changes to the hardware of the vehicle (i.e., hardware associated with the control units and the control units themselves in the vehicle), operations S510, S520, and S530 may be performed again, where the identification of the vehicle remains unchanged.

On the other hand, if a hardware of the vehicle is properly changed by the trusted/verified entities, the next time the user starts the vehicle and operations S510 and S520 are performed, the resulting identification would be different from the previous identification (i.e., the signatures indicated in the new identification will specify the new hardware rather than the previous hardware). Accordingly, the at least one processor may transmit the new identification to the server during operation S530, such that the server may update the identification for the vehicle stored at the server. According to embodiments, the server may store both the new and old identifications of the vehicle, in order to maintain a record of the vehicle.

This process allows for the identification for the vehicle to change, which reduces the risk of non-compliance with privacy laws that permit having an identifier that is persistent and cannot be reset.

It may also be understood that, in order for the trusted/verified entities to properly change the hardware of the vehicle (and subsequently allows all of the control units to successfully secure boot), a diagnostic tool may be used in order to put the vehicle into a diagnostic mode. In such mode, the hardware and/or software of the vehicle may be changed such that the new hardware and/or software would not fail the secure boot.

It may also be understood that, if a 3rd party attacker installs a malicious hardware and/or software onto the vehicle, the next time the user starts the vehicle, the control units associated with such malicious hardware and/or software may fails the secure boot process and operations S540, S550, and S560 may be performed.

This process allows for the identification for the vehicle to, not only acts as an identifier of the vehicle, but also acts as a validation tool for validating whether the vehicle is compromised and unsafe to fully operate, thereby improving the security of the vehicle. Further, since the identification simply specify the combination of the components of the vehicle (i.e., the control units) rather than the specific configurations of such components, privacy main be maintained.

### Example Operations for Determining Whether All of the Plurality of Control Units in the Vehicle have Successfully Secure Booted in the Present Disclosure

FIG. 6 illustrates a flow diagram of an example method 600 for determining whether all of the plurality of control units in a vehicle have successfully secure booted, according to one or more embodiments. One or more operations of method 600 may be part of operation S510 in method 500, and may be performed by at least one processor (e.g., processor 320) of the VIG system. In particular, similar to the descriptions provided in relation to methods 400 and 500, the plurality of control units may include a central control unit and one or more secondary control unit, where one or more operations in method 600 may be performed by the central control unit. Further, during the start-up process of the vehicle, each of the plurality of control units in the vehicle (i.e., the central control unit and the one or more secondary control unit) is configured to perform a secure boot process.

As illustrated in FIG. 6, at operation S610, the at least one processor (i.e., processor of the central control unit) may be configured to perform the secure boot. Descriptions related to the secure boot process are described below with reference to FIG. 7. The method then proceeds to operation S620.

At operation S620, the at least one processor may be configured to determine whether the secure boot was a success. Accordingly, based on determining that the secure boot process was a success, the at least one processor may determine that the central control unit of the plurality of control units has successfully secure booted, and proceed to operation S630. On the other hand, based on determining that the secure boot process was not a success, the at least one processor may determine that the central control unit of the plurality of control units has not successfully secure booted, and proceed to operation S660.

At operation S630, the at least one processor may be configured to transmit a request for a status of one or more secondary control unit to the one or more secondary control unit. According to embodiments, the status of one or more secondary control unit may indicate whether the one or more secondary control unit has successfully secure booted.

For example, if the vehicle comprises of control unit A, control unit B, control unit C, and control unit D where control unit A acts as the central control unit, each of control units A, B, C, and D may be configured to perform a secure boot process. In this regard, once control unit A has successfully secure booted during operations S610 and S620, control unit A may be configured to transmit a request for a status of control units B, C, and D to control units B, C, and D, respectively. The method then proceeds to operation S640.

At operation S640, the at least one processor may be configured to receive the status of one or more secondary control unit from the one or more secondary control unit. According to embodiments, the status of one or more secondary control unit may indicate whether the one or more secondary control unit has successfully secure booted.

According to embodiments, if the one or more secondary control unit has successfully secure booted, the one or more secondary control unit may be configured to transmit the status to the central control unit indicating that the one or more secondary control unit has successfully secure booted. According to embodiments, the one or more secondary control unit may utilize the cryptographic key to cryptographically sign the status, such that the status may serve as an attestation that the one or more secondary control unit has successfully secure booted. For example, if control unit B has a cryptographic key B embedded within during its manufacture and control unit B has successfully secure booted, control unit B may utilize the cryptographic key B to cryptographically sign the status and then transmit the signed status to control unit A indicating that control unit B has successfully secure booted.

According to embodiments, if the one or more secondary control unit has not successfully secure booted, the one or more secondary control unit may be configured to transmit the status to the central control unit indicating that the one or more secondary control unit has not successfully secure booted. For example, if control unit C has not successfully secure booted, control unit C may transmit the status to control unit A indicating that control unit C has not successfully secure booted. The method then proceeds to operation S650.

At operation S650, the at least one processor may be configured to determine whether all of the secondary control unit (i.e., all control units in the vehicle other than the central control unit) have successfully secure booted based on the received status. Accordingly, based on determining that all of the secondary control unit have successfully secure booted, the at least one processor may determine that all of the plurality of control units in the vehicle have successfully secure booted. On the other hand, based on determining that not all of the secondary control unit have successfully secure booted, the at least one processor may determine that not all of the plurality of control units in the vehicle have successfully secure booted.

At operation S660, the at least one processor may be configured to transmit a first failure notification to the one or more secondary control unit. According to embodiments, the first failure notification may indicate that the central control unit has not successfully secure booted. According to embodiments, in response to receiving the first failure notification, the one or more secondary control unit may be configured to select one control unit from the plurality of control units in the vehicle different from the central control unit as a new central control unit. According to embodiments, the one or more secondary control unit may be configured to select a new central control unit based on a vote among the one or more secondary control unit.

It may be understood that, each of the control units may store a list of preferred control units during its manufacture. The list of preferred control units may specify a preference of which control unit should be central control unit. The list of preferred control units may be predefined by the manufacturer of the control unit as appropriate, based on the use of the control unit, type of vehicle, and the like. For example, ECUs that are designed to be used in a Battery Electric Vehicle may specify the Advanced Driver Assistance Systems (ADAS) ECU as the first preferred control unit, since the ADAS has a high computing power.

It may be understood that, according to embodiments, an initial central control unit (e.g., control unit A) may be selected as the central control unit by the one or more secondary control unit based on a vote in a similar manner.

Once the new central control unit is selected, method 600 may be restarted with the new central control unit, where the previous central control unit is now considered as a secondary control unit. For example, if control unit A has not successfully secure booted and control unit D is selected as the new central control unit, method 600 may be restarted with control unit D as the central control unit, and control units A, B, and C as the secondary control units. It may also be understood that, if the new central control unit also fails to successfully secure boot during operation S610, operations S660 may be performed again to select a further new central control unit. For example, if control unit D also fails to successfully secure boot, operation S660 may be performed where control unit B or C may be selected as the further new central control unit.

It may be understood that, if the new central control unit has already successfully secure booted when it was selected, the new central control unit may skip operations S610 and S620.

### Example Secure Boot Process in the Present Disclosure

FIG. 7 illustrates a flow diagram of an example secure boot process, according to one or more embodiments.

As illustrated in FIG. 7, the secure boot process may be separated into four software execution privilege levels/stages: Exception Level (EL) 3 related to the Boot Firmware, Exception Level 2 related to the Hypervisor, Exception Level 1 related to the Operating System (OS), and Exception Level 0 related to the Applications.

The secure boot process may begin at EL3, where the power is turned on and the Boot ROM starts. The Boot ROM may then be configured to launch the Boot Firmware. Once the Boot Firmware is launched, the Boot ROM may be configured to determine whether the Boot Firmware has been tempered with by comparing the Boot Firmware with a previously validated memory image of the Boot Firmware. The previously validated memory image of the Boot Firmware may indicate the most recently validated configuration of the Boot Firmware (e.g., the configuration of the Boot Firmware during manufacture). It may be understood that the previously validated memory image of the Boot Firmware may be stored in the memory of the corresponding control unit. It may be also understood that, if the Boot Firmware was previously updated, such updated Boot Firmware may also be stored in the memory, and may be used for comparison.

The Boot Firmware may also be configured to determine whether or not the associated hardware it is running on is genuine by cryptographically querying the associated hardware. It may be understood that, similar to the control units (e,g, ECUs), each hardware in the vehicle may also have a set of public and private cryptographic keys embedded during its manufacture by the manufacturer in order to specify that such hardware is genuine. Accordingly, the Boot Firmware may be able to cryptographically query the associated hardware based on the keys embedded in the associated hardware, to confirm whether the associated hardware is genuine. Once the Boot ROM has confirmed that the Boot Firmware has not been tempered with and the Boot Firmware has confirmed that the associated hardware is genuine, the Boot ROM may be configured to sign a hash of the Boot Firmware, in order to confirm that the Boot Firmware has been properly booted.

Subsequently, the Boot Firmware may be configured to launch the Hypervisor at EL2, and determine whether the Hypervisor has been tempered with by comparing the Hypervisor with the previously validated memory image of the Hypervisor in the similar manner as the Boot Firmware. Once the Boot Firmware has confirmed that the Hypervisor has not been tempered with, the Boot Firmware may be configured to sign a hash of the Hypervisor, in order to confirm that the Hypervisor has been properly booted.

Subsequently, the Hypervisor may be configured to launch the OS at EL1, and determine whether the OS has been tempered with by comparing the OS with the previously validated memory image of the OS in the similar manner as the Boot Firmware. Once the Hypervisor has confirmed that the OS has not been tempered with, the Hypervisor may be configured to sign a hash of the OS, in order to confirm that the OS has been properly booted.

Subsequently, the OS may be configured to launch the Application at EL0, and determine whether the Application has been tempered with by comparing the Application with the previously validated memory image of the Application in the similar manner as the Boot Firmware. Once the OS has confirmed that the Application has not been tempered with, the OS may be configured to sign a hash of the Application, in order to confirm that the Application has been properly booted.

Accordingly, each level in the boot process may validate the upper level in sequence, which provides a chain level of trust via the cryptographic signatures. As such, once the Application has been properly booted, and the hash of all EL3, EL2, EL1, and EL0 are signed, the control unit would have successfully secure booted. Further, once a control unit has successfully secure booted, an SBOM may be generated listing all components (hardware, software, and the like) associated with such control unit, where a hash of the SBOM may be cryptographically signed and stored in the memory of the control unit. It may be understood that, if a hardware and/or software associated with the control unit is properly changed by the trusted/verified entities and a new hash of the SBOM is generated, the new hash of the SBOM may be cryptographically signed and stored in the memory of the control unit along with the previous hash of the SBOM in order to maintain a record of components of the control unit.

In this regard, once the control unit receives the request for status, the control unit may then transmit the signed hash of the SBOM to indicate that the control unit has successfully secure booted. It may be understood that the above described cryptographic signatures are provided using the cryptographic keys that are embedded in the corresponding control unit.

It may be understood that, if any level fails to boot properly, the boot process may stop and no signature may be provided. Accordingly, the control unit would have failed to successfully secure boot. In this regard, once the control unit receives the request for status, the control unit may then transmit a notification to indicate that the control unit has failed to successfully secure boot.

In view of the above, according to embodiments, the generated identification for the vehicle may include a signed hash of an SBOM that specify the signed hash of a plurality of SBOMs received from a plurality of control units.

According to embodiments, the secure boot process may be completed within 460 milliseconds or 520 milliseconds.

### Example Operations for Re-Booting a Failed Control Unit in the Present Disclosure

FIG. 8 illustrates a flow diagram of an example method 800 for re-booting a failed control unit, according to one or more embodiments. One or more operations of method 800 may be part of operation S540 in method 500, and may be performed by at least one processor (e.g., processor 320) of the VIG system. In particular, similar to the descriptions provided in relation to methods 400 and 500, the plurality of control units may include a central control unit and one or more secondary control unit, where one or more operations in method 800 may be performed by the central control unit. Further, the failed control unit may refer to the control unit of the plurality of control units that has not successfully secure boot.

As illustrated in FIG. 8, at operation S810, the at least one processor (i.e., processor of the central control unit) may be configured to transmit a second failure notification to the server. According to embodiments, the second failure notification may identify the failed control unit and indicate that the failed control unit has not successfully secure boot. According to embodiments, in response to receiving the second failure notification, the server may be configured to transmit data for re-booting the failed control unit. According to embodiments, the data for re-booting the failed control unit may include an Over-The-Air (OTA) patch for resetting the failed control unit back to factory setting.

It may be understood that the vehicle may comprise a primary communication path for internal communication within the vehicle and a secondary communication path for external communication outside of the vehicle. As such, it may be understood that the second failure notification may be transmitted to the server via the secondary communication path. The method then proceeds to operation S820.

At operation S820, the at least one processor may be configured to receive the data for re-booting the failed control unit from the server. The method then proceeds to operation S830.

At operation S830, the at least one processor may be configured to re-boot the failed control unit using the received data. According to embodiments, the at least one processor may be configured to run the patch in order to reset the failed control unit back to factory setting, and then request the failed control unit to being secure boot process again.

### Various Aspects of Embodiments

The foregoing disclosure provides illustration and description, but is not intended

to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s) module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A system comprising:
a memory storage storing computer-executable instructions; and
at least one processor communicatively coupled to the memory storage, wherein the at least one processor is configured to execute the instructions to:
determine whether all of a plurality of control units within a vehicle have successfully secure booted; and
in response to determining that all of the plurality of control units have successfully secure booted, generate an identification for the vehicle based on the plurality of control units that have successfully secure booted.

2. The system according to claim 1, wherein the identification specify a plurality of cryptographic signatures associated with the plurality of control units that have successfully secure booted, and wherein each of the plurality of cryptographic signatures is unique.

3. The system according to claim 1, wherein the at least one processor is configured to execute the instructions to:
in response to determining that not all of the plurality of control units have successfully secure booted, re-boot a failed control unit that has not successfully secure boot;
determine whether the failed control unit has successfully re-booted; and
in response to determining that the failed control unit has not successfully re-booted, disable one or more non-essential functions of the vehicle.

4. The system according to claim 1, wherein:
the plurality of control units comprise a central control unit and one or more secondary control unit;
the central control unit comprises the memory and the at least one processor; and
the at least one processor is configured to execute the instructions to determine whether all of the plurality of control units have successfully secure booted by:
performing a secure boot;
determining whether the secure boot was a success;
in response to determining that the secure boot was a success, transmitting a request for a status of the one or more secondary control unit to the one or more secondary control unit;
receiving the status of the one or more secondary control unit from the one or more secondary control unit; and
determining whether the one or more secondary control unit has successfully secure booted based on the status.

5. The system according to claim 4, wherein:
the at least one processor is configured to execute the instructions to, in response to failing the secure boot, transmitting a first failure notification to the one or more secondary control unit; and
the one or more secondary control unit is configured to, in response to receiving the first failure notification, select one control unit from the plurality of control units different from the central control unit as a new central control unit.

6. The system according to claim 4, wherein the status of the one or more second control unit is cryptographically signed by the corresponding one or more second control unit using a cryptographic key.

7. The system according to claim 1, wherein the plurality of control units comprise an Electronic Control Unit (ECU).

8. The system according to claim 1, wherein the identification comprises a Software Bill of Material (SBOM).

9. The system according to claim 1, wherein the at least one processor is configured to execute the instructions to transmit the identification to a server via an Elliptic Curve Integrated Encryption Scheme (ECIES).

10. A method, comprising:
determining whether all of a plurality of control units within a vehicle have successfully secure booted; and
in response to determining that all of the plurality of control units have successfully secure booted, generating an identification for the vehicle based on the plurality of control units that have successfully secure booted.

11. The method according to claim 10, wherein the identification specify a plurality of cryptographic signatures associated with the plurality of control units that have successfully secure booted, and wherein each of the plurality of cryptographic signatures is unique.

12. The method according to claim 10, further comprising:
in response to determining that not all of the plurality of control units have successfully secure booted, re-booting a failed control unit that has not successfully secure boot;
determining whether the failed control unit has successfully re-booted; and
in response to determining that the failed control unit has not successfully re-booted, disabling one or more non-essential functions of the vehicle.

13. The method according to claim 10, wherein:
the plurality of control units comprise a central control unit and one or more secondary control unit; and
the determining whether all of the plurality of control units within the vehicle have successfully secure booted comprises:
performing, by the central control unit, a secure boot;
determining, by the central control unit, whether the secure boot was a success;
in response to determining that the secure boot was a success, transmitting, by the central control unit, a request for a status of the one or more secondary control unit to the one or more secondary control unit;
receiving, by the central control unit, the status of the one or more secondary control unit from the one or more secondary control unit; and
determining, by the central control unit, whether the one or more secondary control unit has successfully secure booted based on the status.

14. The method according to claim 13, further comprising:
in response to failing the secure boot, transmitting, by the central control unit, a first failure notification to the one or more secondary control unit; and
in response to receiving the first failure notification, selecting, by the one or more secondary control unit, one control unit from the plurality of control units different from the central control unit as a new central control unit.

15. The method according to claim 13, wherein the status of the one or more second control unit is cryptographically signed by the corresponding one or more second control unit using a cryptographic key.

16. The method according to claim 10, wherein the plurality of control units comprise an Electronic Control Unit (ECU).

17. The method according to claim 10, wherein the identification comprises a Software Bill of Material (SBOM).

18. The method according to claim 10, wherein the at least one processor is configured to execute the instructions to transmit the identification to a server via an Elliptic Curve Integrated Encryption Scheme (ECIES).

19. A non-transitory computer-readable recording medium having recorded thereon instructions executable by at least one processor to cause the at least one processor to perform a method comprising:
determining whether all of a plurality of control units within a vehicle have successfully secure booted; and
in response to determining that all of the plurality of control units have successfully secure booted, generating an identification for the vehicle based on the plurality of control units that have successfully secure booted.

20. The non-transitory computer-readable recording medium according to claim 19, wherein the identification specify a plurality of cryptographic signatures associated with the plurality of control units that have successfully secure booted, and wherein each of the plurality of cryptographic signatures is unique.
